(19) United States
(12) Patent Application Publication
(10) Pub. No.: US 2024/0097157 A1
(43) Pub. Date: Mar. 21, 2024

(54) HYDROGEN SUPPLY SYSTEM FOR FUEL CELLS AND METHOD OF CONTROLLING THE SAME

(71) Applicants: Hyundai Motor Company, Seoul (KR); Kia Corporation, Seoul (KR)

(72) Inventors: Sang Wook HAN, Seoul (KR); Jae Won JUNG, Suwon-Si (KR)

(73) Assignees: Hyundai Motor Company, Seoul (KR); Kia Corporation, Seoul (KR)

(21) Appl. No.: 18/135,454

(22) Filed: Apr. 17, 2023

(30) Foreign Application Priority Data
Sep. 20, 2022 (KR) 10-2022-0118753

(51) Int. Cl. H01M 8/04089; H01M 8/04082; H01M 8/0432; H01M 8/04746; H01M 8/2465

(52) U.S. Cl. CPC H01M 8/04089; H01M 8/04201; H01M 8/04328; H01M 8/04761; H01M 8/2465

(57) ABSTRACT

A hydrogen supply system for fuel cells and a method of controlling the same include a hydrogen supplier connected to a hydrogen provider and configured to receive hydrogen from the hydrogen provider through a supply valve, a supply line, a discharge line, a discharge valve provided on the hydrogen supplier to discharge by-products, collected in the hydrogen supplier, to the outside thereof, and a controller electrically connected to the supply valve and configured to set a basic duty of the supply valve based on a basic control map, to set a compensation duty of the supply valve depending on feedback control, and to set a final duty of the supply valve through the basic duty and the compensation duty.

### CROSS-REFERENCE TO RELATED APPLICATION

The present application claims priority to Korean Patent Application No. 10-2022-0118753, filed on Sep. 20, 2022, the entire contents of which is incorporated herein for all purposes by this reference.

### BACKGROUND OF THE PRESENT DISCLOSURE

### Field of the Present Disclosure

The present disclosure relates to a hydrogen supply system for fuel cells, which allows a fuel cell stack to normally generate power even when no pressure sensor is provided at an anode in the fuel cell stack, and reduces use of sensors to improve durability of the system, to be effectively operable without stopping power generation for maintenance, to reduce the package of the system and to achieve cost reduction, and a method of controlling the hydrogen supply system.

### Description of Related Art

A fuel cell system is an apparatus which receives hydrogen and air from the outside thereof and produces electrical energy through electrochemical reactions in a fuel cell stack, and may be used as a power source for driving a motor of an eco-friendly vehicle, such as a fuel cell electric vehicle (FCEV). Furthermore, an industrial power generation system is constructed using the fuel cell system.

The fuel cell system includes the fuel cell stack formed by stacking a plurality of fuel cells, a fuel supply system configured to supply hydrogen as fuel to the fuel cell stack, an air supply system configured to supply oxygen as an oxidizer necessary in the electrochemical reactions, and a thermal management system configured to control the temperature of the fuel cell stack.

The fuel supply system decompresses compressed hydrogen in a hydrogen tank and then supplies the decompressed hydrogen to an anode (i.e., a fuel electrode) in the fuel cell stack, and the air supply system operates an air compressor to supply absorbed external air to a cathode (i.e., an air electrode) in the fuel cell stack.

When hydrogen is supplied to the anode and oxygen is supplied to the cathode in the fuel cell stack, protons are separated through catalyst reaction at the anode. The separated protons migrate to the cathode, i.e., an oxidation electrode, through an electrolyte membrane, and the protons and electrons, which are separated from each other at the anode, and oxygen undergo electrochemical reactions at the oxidation electrode and thus produce electrical energy. Concretely, the electrochemical oxidation of hydrogen occurs at the anode, electrochemical reduction of oxygen occurs at the cathode, electricity and heat are produced due to migration of the generated electrons, and vapor or water is generated by chemical bonding between hydrogen and oxygen.

A discharge device configured to discharge by-products, such as vapor or water and heat, generated during the process of producing electrical energy of the fuel cell stack, and unreacted hydrogen and oxygen is provided, and gases, such as vapor, hydrogen and oxygen, are discharged to the atmosphere through an exhaust passage.

The electrochemical reactions occurring in the fuel cells are represented by reaction formulae, as below.

[Reaction at Anode] 2H₂(g)→4H⁺(aq.)+4e⁻

[Reaction at Cathode] O₂(g)+4H⁺(aq.)+4e⁻→2H₂O(l)

[Whole Reaction] 2H₂(g)+O₂(g)→2H₂O(l)+Electrical Energy+Thermal Energy

As represented in the above reaction formulae, hydrogen molecules are decomposed into four protons and four electrons. The electrons migrate to the cathode through an external circuit and thus produce current (electrical energy), the protons migrate to the cathode through the electrolyte membrane and thus cause reduction reaction, and water and heat are generated as the by-products of the electrochemical reactions.

Fuel cells for power generation business need to be operated for a long time period and give weight to stable power generation in terms of characteristics of the power generation business, and thus, durability of parts is more important. Furthermore, it is determined that, in the fuel cells for power generation business, a hydrogen pressure sensor is frequently exposed to a high-pressure situation, compared to fuel cell systems for vehicles (i.e., during operation for power generation), and thereby, the deterioration rate of the hydrogen pressure sensor is rapid, compared to the fuel cell systems for vehicles. Therefore, costs to stop power generation or to replace the hydrogen pressure sensor with a new one due to deterioration of the sensor are incurred, and thus, a solution to the present problem is required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a hydrogen supply system for fuel cells, which allows a fuel cell stack to normally generate power even when no pressure sensor is provided at an anode in the fuel cell stack, and reduces use of sensors to improve durability of the system, to be effectively operable without stopping power generation for maintenance, to reduce the package of the system and to achieve cost reduction, and a method of controlling the hydrogen supply system.

In accordance with an aspect of the present disclosure, the above and other objects may be accomplished by the provision of a hydrogen supply system for fuel cells, the hydrogen supply system including a hydrogen supplier fluidically-connected to a hydrogen provider through a hydrogen providing line and configured to receive hydrogen from the hydrogen provider through a supply valve, a supply line fluidically connecting the hydrogen supplier to an inlet of an anode in a fuel cell stack, a discharge line fluidically connecting the hydrogen supplier to an outlet of the anode in the fuel cell stack, a discharge valve provided on the hydrogen supplier to discharge by-products, collected in the hydrogen supplier, outside, and a controller electrically connected to the supply valve and configured to set a basic duty of the supply valve based on a basic control map, to set a compensation duty of the supply valve depending on feedback control, and to set a final duty of the supply valve through the basic duty and the compensation duty.

The basic control map of the controller may be a data map configured so that a current demand is received as an input thereof and a duty ratio of the supply valve is output therefrom.

The controller may set the basic duty of the supply valve to a different value depending on a starting state, a power generating state, or a stopped state of the fuel cell stack.

The controller may set the compensation duty of the supply valve so that a current power generation amount of the fuel cell stack follows a target power generation amount.

The controller may set the compensation duty of the supply valve depending on operation of the discharge valve.

The controller may be configured to determine a flow rate of the by-products discharged outside of the hydrogen supplier by opening the discharge valve, and may set the compensation duty of the supply valve through the determined flow rate of the by-products.

The controller may set the compensation duty of the supply valve so that a current power generation amount of the fuel cell stack follows a target power generation amount, when the discharge valve is closed, and may set the compensation duty of the supply valve depending on a flow rate of the by-products discharged outside through the discharge valve, when the discharge valve is opened.

The controller may set the final duty of the supply valve through a temperature of the anode in the fuel cell stack or a temperature of a coolant, the basic duty and the compensation duty.

The controller may set a duty gain depending on a temperature of the anode in the fuel cell stack or a temperature of a coolant, and may set the final duty through the duty gain, the basic duty and the compensation duty.

The controller may set the final duty by multiplying the basic duty by the duty gain and then adding the compensation duty thereto, and may control the supply valve based on the final duty.

The controller may have a temperature map configured so that a temperature is received as an input thereof and the duty gain is output, and may set the duty gain by inputting the temperature of the anode or the temperature of the coolant to the temperature map.

The hydrogen supply system may further include a pressure sensor provided on the hydrogen providing line to measure a pressure of hydrogen in the hydrogen providing line.

The controller may maintain the final duty of the supply valve above a minimum value, when a pressure of the hydrogen providing line is less than a reference value and a difference between a current duty of the supply valve and the basic duty of the supply valve is less than a set value.

The controller may maintain the final duty of the supply valve below a maximum value, when a pressure of the hydrogen providing line is greater than a reference value and a difference between a current duty of the supply valve and the basic duty of the supply valve is greater than a set value.

In accordance with another aspect of the present disclosure, there is provided a method of controlling a hydrogen supply system for fuel cells, the method including setting, by a controller, a basic duty of a supply valve configured to supply hydrogen to a hydrogen supplier, setting, by the controller, a compensation duty of the supply valve depending on feedback control, setting, by the controller, a final duty of the supply valve through the basic duty and the compensation duty, and controlling, by the controller, the supply valve depending on the set final duty.

In setting the compensation duty of the supply valve depending on the feedback control, the controller may set the compensation duty of the supply valve so that a current power generation amount of a fuel cell stack follows a target power generation amount, when a discharge valve configured to discharge by-products, collected in the hydrogen supplier, outside is closed, and may set the compensation duty of the supply valve depending on a flow rate of the by-products discharged outside through the discharge valve, when the discharge valve is opened.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic view showing a hydrogen supply system for fuel cells according to an exemplary embodiment of the present disclosure;

FIG. 2 is a flowchart representing a method of controlling the hydrogen supply system according to an exemplary embodiment of the present disclosure;

FIG. 3 is a graph representing relations between the duty ratio of a hydrogen supply valve and a supply flow rate through the hydrogen supply valve;

FIG. 4 is a graph representing relations between the temperature of a coolant and the saturation vapor pressure of an anode;

FIG. 5 is a graph representing relations between the hydrogen concentration of the anode and the saturation vapor pressure of the anode;

FIG. 6 is a graph representing relations between the hydrogen concentration of the anode and the temperature of the coolant; and

FIG. 7 is a graph representing relations between the temperature of the coolant and the duty gain of the hydrogen supply valve.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to a same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Reference will now be made in detail to exemplary embodiments of the present disclosure, examples of which are illustrated in the accompanying drawings. Wherever possible, the same reference numbers will be used throughout the drawings to refer to the same or like portions.

In the following description of the exemplary embodiments of the present disclosure, a detailed description of known functions and configurations incorporated herein will be omitted when it may make the subject matter of the present disclosure rather unclear. Furthermore, the accompanying drawings will be exemplarily provided to describe the exemplary embodiments of the present disclosure, and should not be construed as being limited to the exemplary embodiments set forth herein, and it will be understood that the exemplary embodiments of the present disclosure are provided only to completely include the present disclosure and cover modifications, equivalents or alternatives which come within the scope and technical range of the present disclosure.

As used herein, singular forms may be intended to include plural forms as well, unless the context clearly indicates otherwise.

In the following description of the embodiments, the terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

In the following description of the embodiments, suffixes, such as “module”, “part” and “unit”, are provided or used interchangeably merely in consideration of ease in statement of the specification, and do not have meanings or functions distinguished from one another.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present.

Furthermore, a controller may include a communication device configured to communicate with other controllers or sensors to control functions served by the controller, a memory configured to store operating systems or logic commands and input and output information, and at least one processor configured to perform determination, calculation, decision, etc. required to control the functions.

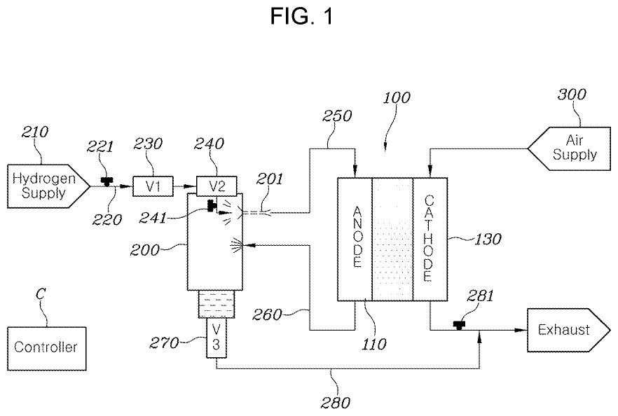

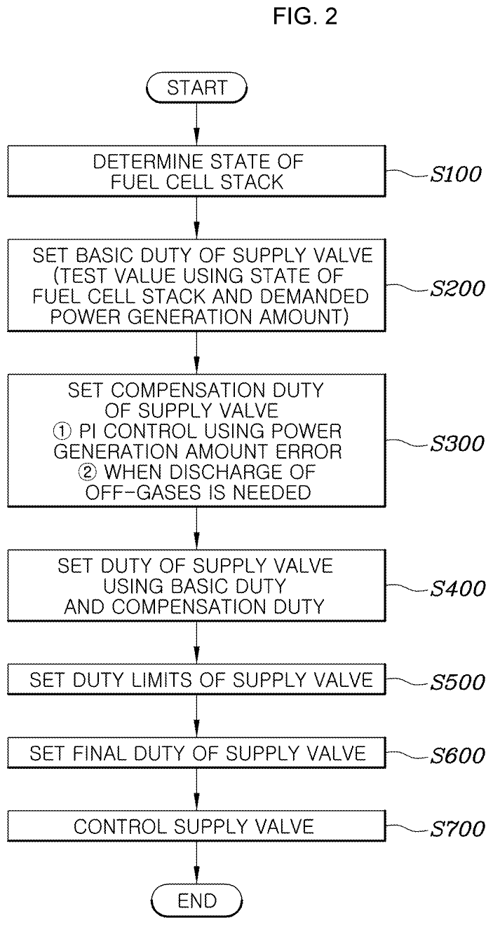

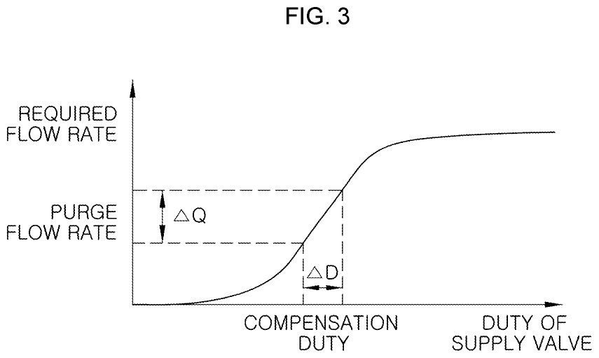

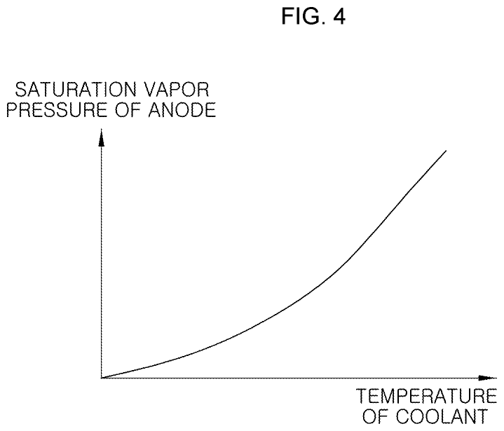

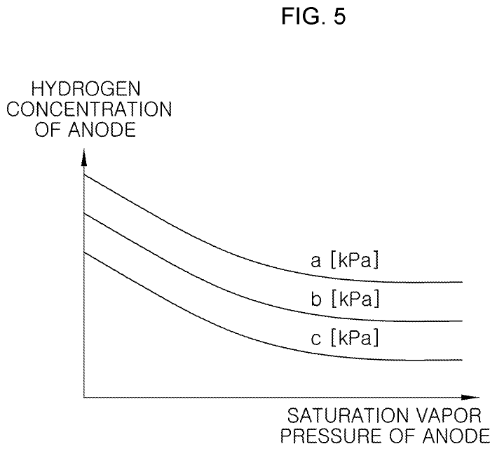

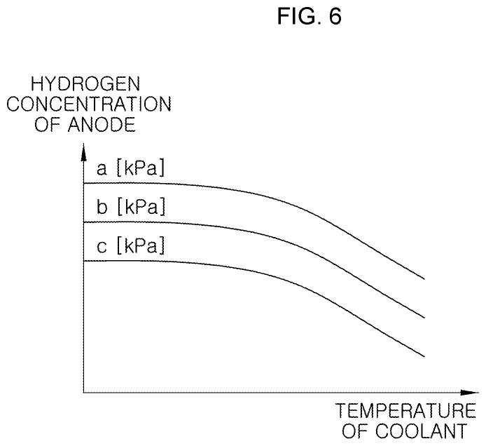

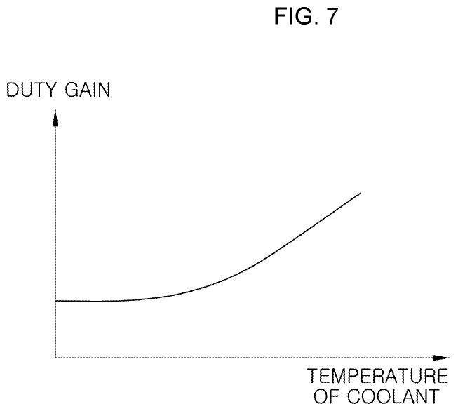

FIG. 1 is a schematic view showing a hydrogen supply system for fuel cells according to various exemplary embodiments of the present disclosure, FIG. 2 is a flowchart representing a method of controlling the hydrogen supply system according to various exemplary embodiments of the present disclosure, FIG. 3 is a graph representing relations between the duty ratio of a hydrogen supply valve and a supply flow rate through the hydrogen supply valve, FIG. 4 is a graph representing relations between the temperature of a coolant and the saturation vapor pressure of an anode, FIG. 5 is a graph representing relations between the hydrogen concentration of the anode and the saturation vapor pressure of the anode, FIG. 6 is a graph representing relations between the hydrogen concentration of the anode and the temperature of the coolant, and FIG. 7 is a graph representing relations between the temperature of the coolant and the duty gain of the hydrogen supply valve.

First, referring to FIG. 1 showing a hydrogen supply system for fuel cells according to various exemplary embodiments of the present disclosure, the hydrogen supply system according to an exemplary embodiment of the present disclosure includes a hydrogen supplier 200 connected to a hydrogen provider 210 through a hydrogen providing line 220 and configured to receive hydrogen from the hydrogen provider 210 through a supply valve 240, a supply line 250 configured to connect the hydrogen supplier 200 to an inlet of an anode 110 in a fuel cell stack 100, a discharge line 260 configured to connect the hydrogen supplier 200 to an outlet of the anode 110 in the fuel cell stack 100, a discharge valve 270 provided on the hydrogen supplier 200 to discharge by-products, collected in the hydrogen supplier 200, to the outside thereof, and a controller C configured to set a basic duty of the supply valve 240 based on a basic control map, to set a compensation duty of the supply valve 240 depending on feedback control, and to set a final duty of the supply valve 240 through the basic duty and the compensation duty.

A fuel cell system according to an exemplary embodiment of the present disclosure is suitable as a fuel cell system for power generation, but does not exclude use as a fuel cell system for vehicles.

In the fuel cell system, as shown in FIG. 1, a hydrogen supply system is provided aside the anode 110 in the fuel cell stack 100, and an air supply system is provided aside a cathode 130 in the fuel cell stack 100 including the fuel cells, each of which includes the anode 110 and the cathode 130.

Concretely, the hydrogen provider 210, such as a hydrogen tank, is connected to the hydrogen supplier 200 through the hydrogen providing line 220. A pressure sensor 221 and a hydrogen cut-off valve 230 are provided on the hydrogen providing line 220. Furthermore, the supply valve 240 is provided between the hydrogen providing line 220 and the hydrogen supplier 200, and the amount of hydrogen supplied is adjusted through the control of the supply valve 240.

An ejector 201 is provided on the hydrogen supplier 200, and the ejector 201 is connected to the inlet of the anode 110 in the fuel cell stack 100 by the supply line 250.

Furthermore, the hydrogen supplier 200 is connected to the outlet of the anode 110 in the fuel cell stack 100 by the discharge line 260, and thus, the by-products are collected in the hydrogen supplier 200. A water trap is provided on the hydrogen supplier 200, and the discharge valve 270 is provided on the water trap, and thus discharges the by-products in the hydrogen supplier 200 to the outside. Concretely, an exhaust line 280 connects the water trap to the outlet of the cathode 130 in the fuel cell stack 100, and the discharge valve 270 is provided on the exhaust line 280 to exhaust the by-products to the outside. An air supplier 300, such as a compressor, is connected to the cathode 130 in the fuel cell stack 100, and a pressure sensor 281 is provided at the outlet of the cathode 130.

The controller C is configured to control the supply valve 240 to adjust the amount of hydrogen supplied to the fuel cell stack 100. The controller C sets the basic duty of the supply valve 240 based on the basic control map, sets the compensation duty of the supply valve 240 depending on feedback control, and sets the final duty of the supply valve 240 through the temperature of the anode 110 in the fuel cell stack 100 or the temperature of the coolant, the basic duty and the compensation duty.

In hydrogen pressure control in a general fuel cell vehicle, the duty of a hydrogen supply valve is determined using a target pressure, determined by a demanded power generation amount and the situation of an air compressor, and a hydrogen pressure sensor provided at the inlet of an anode. Accordingly, the required amount of hydrogen is supplied to a fuel cell stack by controlling the flow rate hydrogen supplied to the fuel cell stack.

However, in case of fuel cells for power generation business, a plurality of fuel cell system modules is connected in parallel, and the fuel cells for power generation business have a constant output and a low frequency of starts and stops to achieve firm output, and need to be operated for a long time period. Furthermore, a hydrogen pressure sensor is exposed to a high pressure situation for a long time, compared to the fuel cell systems for vehicles, and thus requires durability.

In the case in which a pressure sensor is located between an ejector and the inlet of an anode, when the durability of the corresponding pressure sensor is not high, the pressure sensor breaks down frequently, the fuel cell system for power generation needs to be stopped to replace the broken-down sensor with a new one, and thus, the system includes reduced overall power generation efficiency and causes an increase in cost.

Therefore, the present disclosure is directed to providing a method of controlling the supply valve 240, in which no pressure sensor is provided between the ejector 201 and the inlet of the anode 110 to achieve efficiency improvement and cost reduction, and a proper amount of hydrogen is supplied to the fuel cell stack 100 even though there is no pressure sensor between the ejector 201 and the inlet of the anode 110.

In an exemplary embodiment of the present disclosure, because there is no pressure sensor between the ejector 201 and the inlet of the anode 110, it is difficult to accurately detect the pressure or the flow rate of hydrogen supplied to the fuel cell stack 100. However, considering that the fuel cells for power generation business are operated so that the required output thereof is fixed, and exhibit a directly proportional relationship between a current demand and the duty ratio of the supply valve 240, the supply amount of hydrogen depending on a starting state, an operating state or a stopped state of the fuel cell stack 100 is determined only by the duty of the supply valve 240. Accordingly, the fuel cell stack 100 may maintain the state in which power generation is sustainable even though a hydrogen pressure sensor between the ejector 201 and the inlet of the anode 110 is omitted, and may achieve cost reduction, simultaneously.

Concretely, the controller C sets the basic duty of the supply valve 240 based on the basic control map. The basic control map of the controller C is a data map in which the current demand or the demanded power generation amount of the fuel cell stack 100 is received as an input thereof and the duty ratio of the supply valve 240 is output. Furthermore, the controller C may set the basic duty of the supply valve 240 to a different value depending on the starting state, a power generating state, i.e., the operating state, or the stopped state of the fuel cell stack 100.

That is, the states of the fuel cell stack 100 include the starting state, the power generating state, and the stopped state. In the case in which the fuel cell stack 100 is in the starting state or the stopped state, the fuel cells are not ready to emit a stable output, and thus, the controller C determines the basic duty of the supply valve 240 through a series of sequences. In the case in which the fuel cell stack 100 is in the power generating state, the controller C determines the basic duty of the supply valve depending on the demanded power generation amount.

In the fuel cells for power generation business, the output of the fuel cells is almost not changed, and is constant in the power generating state, and thus, it is possible to supply a proper amount of hydrogen to the fuel cells for power generation business to some degree based on the basic control map.

However, to supply the more precise amount of hydrogen to the fuel cell stack 100, the controller C sets the compensation duty of the supply valve 240 depending on feedback control, and then reflects the compensation duty. To determine the compensation duty, the controller C may set the compensation duty of the supply valve 240 so that the current power generation amount of the fuel cell stack 100 follows a target power generation amount. Otherwise, the controller C may set the compensation duty of the supply valve 240 depending on operation of the discharge valve 270.

Concretely, the power generation amount of the fuel cell stack 100 is affected by an air supply amount, a stack temperature, and a hydrogen partial pressure. Thereamong, shortage in the hydrogen partial pressure reduces possibility of chemical reaction in a membrane and causes stack voltage imbalance, and in the present situation, the stack voltage imbalance may be solved by supplying an excessive amount of hydrogen to increase the hydrogen partial pressure to a designated level or more.

Therefore, when the flow rate of air is constant and the temperature of the fuel cell stack 100 is within a designated range, the compensation duty of the supply valve 240 is determined through PI control using an error between the demanded power generation amount and the current power generation amount of the fuel cell stack 100.

When the discharge valve 270 is opened or closed, a disturbance occurs in direct proportion to a differential pressure between the pressure of the anode 110 and the pressure of supplied air. Here, the pressure of the anode 110 may be determined depending on the duty of the supply valve 240, and thus, the compensation duty may be determined by a flow rate which is expected to be discharged due to opening of the discharge valve 270.

FIG. 3 is a graph representing relations between the duty ratio of the hydrogen supply valve 240 and a supply flow rate through the hydrogen supply valve 240. Hydrogen supply may be increased by adding the compensation duty ΔD, corresponding to the loss ΔQ of the flow rate due to opening of the discharge valve 270, to the basic duty.

Therefore, the controller C may determine the flow rate of the by-products discharged to the outside by opening the discharge valve 270, and may set the compensation duty of the supply valve 240 through the determined flow rate of the by-products.

Furthermore, the controller C may set the compensation duty of the supply valve 240 so that the current power generation amount of the fuel cell stack 10 follows the target power generation amount, when the discharge valve 270 is closed, and may set the compensation duty of the supply valve 240 depending on the flow rate of the by-products discharged to the outside through the discharge valve 270, when the discharge valve 270 is opened.

Finally, the controller C may set the final duty of the supply valve 240 through the temperature of the anode 110 in the fuel cell stack 100 or the temperature of the coolant, the basic duty and the compensation duty.

Concretely, the controller C may set a duty gain depending on the temperature of the anode 110 in the fuel cell stack 100 or the temperature of the coolant, and may set the final duty through the duty gain, the basic duty and the compensation duty.

The controller C may set the final duty by multiplying the basic duty by the duty gain and then adding the compensation duty thereto, and may control the supply valve 240 based on the final duty.

In relation to the duty gain, the controller C may have a temperature map in which a temperature is received as an input thereof and the duty gain is output, and may set the duty gain by inputting the temperature of the anode 110 or the temperature of the coolant to the temperature map.

FIG. 4 is a graph representing relations between the temperature of the coolant and the saturation vapor pressure of the anode, FIG. 5 is a graph representing relations between the hydrogen concentration of the anode and the saturation vapor pressure of the anode, FIG. 6 is a graph representing relations between the hydrogen concentration of the anode and the temperature of the coolant, and FIG. 7 is a graph representing relations between the temperature of the coolant and the duty gain of the hydrogen supply valve.

In the fuel cell stack 100, the saturation vapor pressure of the anode 110 is increased as the temperature of the anode 110 (or the temperature of the coolant) is increased, as shown in FIG. 4, and the hydrogen concentration of the anode 110 is decreased as the saturation vapor pressure of the anode 110 is increased under the same pressure condition, as shown in FIG. 5. FIG. 5 and FIG. 6 show changes under different pressure conditions (a>b>c) of the anode 110. Therefore, since the hydrogen concentration of the anode 110 is decreased at the same pressure as the temperature of the coolant is increased, as shown in FIG. 6, a gain value to determine the final duty of the supply valve 240 may be set through the relations shown in FIG. 7.

After the duty gain has been determined, the final duty of the supply valve 240 is determined by Equation below.

Final Duty of Supply Valve=(Gain at Each Temperature of Coolant)×Basic Duty+Compensation Duty

The pressure sensor 221 is provided on the hydrogen providing line 220 to measure the pressure of hydrogen.

Furthermore, the controller C may maintain the final duty of the supply valve 240 above a minimum value, when the pressure of the hydrogen providing line 220 is less than a reference value and a difference between the current duty and the basic duty of the supply valve 240 is less than a set value.

Moreover, the controller C may maintain the final duty of the supply valve 240 below a maximum value, when the pressure of the hydrogen providing line 220 is greater than another reference value and the difference between the current duty and the basic duty of the supply valve 240 is greater than another set value.

Concretely, the flow rate of hydrogen supplied to the fuel cell stack 100 through the supply valve 240 may be increased in proportion to the opening amount (i.e., the duty) of the supply valve 240 and the pressure at the upstream portion of the supply valve 240. When the pressure of the hydrogen providing line 220 is greater than a designated level, the flow rate of hydrogen at the basic duty of the supply valve 40 required for power generation, which is more than necessary, may be supplied. Therefore, the current duty of the supply valve 240 is compared with the basic duty predetermined in proportion to the power generation amount, and when the current duty of the supply valve 240 is higher than the basic duty, it is determined that an excessive fuel amount, i.e., hydrogen, is supplied. Here, control that reduces the average of flow rates supplied to the fuel cell stack 100 is performed by restricting the maximum value of the duty for a designated time. In the opposite case, it is determined that an insufficient amount of hydrogen is supplied, and the average of flow rates supplied to the fuel cell stack 100 is increased by restricting the minimum value of the duty.
1). (Pressure of Hydrogen Providing Line<First Reference Value) and (Current Duty-Basic Duty=Δ Duty<D1): Determination as Shortage, Restriction on Minimum Value of Duty of Supply Valve
2). (Pressure of Hydrogen Providing Line>Second Reference Value) and (Current Duty-Basic Duty=Δ Duty>D2): Determination as Excess, Restriction on Maximum Value of Duty of Supply Valve

FIG. 2 is a flowchart representing a method of controlling the hydrogen supply system according to various exemplary embodiments of the present disclosure. The method of controlling the hydrogen supply system according to various exemplary embodiments of the present disclosure includes detecting, by the controller C, the state of the fuel cell stack 100 and setting the basic duty of the supply valve 240 configured to supply hydrogen to the hydrogen supplier 200 (S100 and S200), setting, by the controller C, the compensation duty of the supply valve 240 depending on feedback control (S300), setting, by the controller C, the final duty of the supply valve 240 through the temperature of the anode 110 in the fuel cell stack 100 or the temperature of the coolant, the basic duty and the compensation duty (S400), and controlling, by the controller C, the supply valve 240 depending on the set final duty (S700).

In setting the compensation duty of the supply valve 240 depending on feedback control (S300), the controller C may set the compensation duty of the supply valve 240 so that the current power generation amount of the fuel cell stack 10 follows the target power generation amount, when the discharge valve 270 is closed, and may set the compensation duty of the supply valve 240 depending on the flow rate of the by-products discharged to the outside through the discharge valve 270, when the discharge valve 270 is opened.

Furthermore, the method of controlling the hydrogen supply system according to various exemplary embodiments of the present disclosure may further include maintaining, by the controller C, the final duty of the supply valve 240 above the minimum value, when the pressure of the hydrogen providing line 220 is less than a reference value and the difference between the current duty and the basic duty of the supply valve 240 is less than a set value, or maintaining the final duty of the supply valve 240 below the maximum value, when the pressure of the hydrogen providing line 220 is greater than another reference value and the difference between the current duty and the basic duty of the supply valve 240 is greater than another set value (S500). Furthermore, the method of controlling the hydrogen supply system according to various exemplary embodiments of the present disclosure may further include determining the final duty based on the above result of duty restriction (S600).

The hydrogen supply system and the method of controlling the same according to an exemplary embodiment of the present disclosure allow the fuel cell stack to normally generate power even when no pressure sensor is provided at the anode in the fuel cell stack, and reduce use of sensors, being configured for improving durability of the system, being effectively operable without stopping power generation for maintenance, reducing the package of the system and achieving cost reduction.

As is apparent from the above description, a hydrogen supply system for fuel cells and a method of controlling the same according to an exemplary embodiment of the present disclosure allow a fuel cell stack to normally generate power even when no pressure sensor is provided at an anode in the fuel cell stack, and reduce use of sensors, being configured for improving durability of the system, being effectively operable without stopping power generation for maintenance, reducing the package of the system and achieving cost reduction.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A hydrogen supply system for fuel cells, the hydrogen supply system comprising:
a hydrogen supplier fluidically-connected to a hydrogen provider through a hydrogen providing line and configured to receive hydrogen from the hydrogen provider through a supply valve connected to the hydrogen providing line and the hydrogen supplier;
a supply line fluidically connecting the hydrogen supplier to an inlet of an anode in a fuel cell stack;
a discharge line fluidically connecting the hydrogen supplier to an outlet of the anode in the fuel cell stack;
a discharge valve provided on the hydrogen supplier to discharge by-products, collected in the hydrogen supplier, outside of the hydrogen supplier; and
a controller electrically connected to the supply valve and configured to set a basic duty of the supply valve based on a basic control map, to set a compensation duty of the supply valve depending on feedback control, and to seta final duty of the supply valve through the basic duty and the compensation duty.

2. The hydrogen supply system of claim 1, wherein the basic control map of the controller is a data map configured so that a current demand is received as an input thereof and a duty ratio of the supply valve is output therefrom.

3. The hydrogen supply system of claim 1, wherein the controller is configured to set the basic duty of the supply valve to a different value depending on a starting state, a power generating state, or a stopped state of the fuel cell stack.

4. The hydrogen supply system of claim 1, wherein the controller is configured to set the compensation duty of the supply valve so that a current power generation amount of the fuel cell stack follows a target power generation amount.

5. The hydrogen supply system of claim 1, wherein the controller is configured to set the compensation duty of the supply valve depending on operation of the discharge valve.

6. The hydrogen supply system of claim 5, wherein the controller is configured to determine a flow rate of the by-products discharged outside of the hydrogen supplier by opening the discharge valve, and to set the compensation duty of the supply valve through the determined flow rate of the by-products.

7. The hydrogen supply system of claim 1, wherein the controller is configured to set the compensation duty of the supply valve so that a current power generation amount of the fuel cell stack follows a target power generation amount, when the discharge valve is closed, and to set the compensation duty of the supply valve depending on a flow rate of the by-products discharged outside through the discharge valve, when the discharge valve is opened.

8. The hydrogen supply system of claim 1, wherein the controller is configured to set the final duty of the supply valve through a temperature of the anode in the fuel cell stack or a temperature of a coolant, the basic duty and the compensation duty.

9. The hydrogen supply system of claim 1, wherein the controller is configured to set a duty gain depending on a temperature of the anode in the fuel cell stack or a temperature of a coolant, and to set the final duty through the duty gain, the basic duty and the compensation duty.

10. The hydrogen supply system of claim 9, wherein the controller is configured to set the final duty by multiplying the basic duty by the duty gain and then adding the compensation duty thereto, and is configured to control the supply valve based on the set final duty.

11. The hydrogen supply system of claim 9, wherein the controller includes a temperature map configured so that a temperature is received as an input thereof and the duty gain is output, and is configured to set the duty gain by inputting the temperature of the anode or the temperature of the coolant to the temperature map.

12. The hydrogen supply system of claim 1, further including a pressure sensor provided on the hydrogen providing line to measure a pressure of hydrogen in the hydrogen providing line.

13. The hydrogen supply system of claim 1, wherein the controller is configured to maintain the final duty of the supply valve above a minimum value, when a pressure of the hydrogen providing line is less than a reference value and a difference between a current duty of the supply valve and the basic duty of the supply valve is less than a set value.

14. The hydrogen supply system of claim 1, wherein the controller is configured to maintain the final duty of the supply valve below a maximum value, when a pressure of the hydrogen providing line is greater than a reference value and a difference between a current duty of the supply valve and the basic duty of the supply valve is greater than a set value.

15. A method of controlling a hydrogen supply system for fuel cells of a fuel cell stack, the method comprising:
setting, by a controller, a basic duty of a supply valve configured to supply hydrogen to a hydrogen supplier;
setting, by the controller, a compensation duty of the supply valve depending on feedback control;
setting, by the controller, a final duty of the supply valve through the basic duty and the compensation duty; and
controlling, by the controller electrically connected to the supply valve, the supply valve depending on the set final duty.

16. The method of claim 15, wherein, in setting the compensation duty of the supply valve depending on the feedback control, the controller is configured to set the compensation duty of the supply valve so that a current power generation amount of the fuel cell stack follows a target power generation amount, when a discharge valve configured to discharge by-products, collected in the hydrogen supplier, outside of the hydrogen supplier is closed, and to set the compensation duty of the supply valve depending on a flow rate of the by-products discharged outside through the discharge valve, when the discharge valve is opened.

17. The method of claim 15, wherein the controller is configured to set the basic duty of the supply valve to a different value depending on a starting state, a power generating state, or a stopped state of the fuel cell stack.

18. The method of claim 15, wherein the controller is configured to set the final duty of the supply valve through a temperature of an anode in the fuel cell stack or a temperature of a coolant, the basic duty and the compensation duty.

19. The method of claim 15, wherein the controller is configured to set a duty gain depending on a temperature of an anode in the fuel cell stack or a temperature of a coolant, and to set the final duty through the duty gain, the basic duty and the compensation duty.

20. The method of claim 15,
wherein the controller is configured to maintain the final duty of the supply valve above a minimum value, when a pressure of a hydrogen providing line connecting a hydrogen provider and the supply valve is less than a reference value and a difference between a current duty of the supply valve and the basic duty of the supply valve is less than a set value, and.
wherein the controller is configured to maintain the final duty of the supply valve below a maximum value, when a pressure of the hydrogen providing line is greater than the reference value and a difference between the current duty of the supply valve and the basic duty of the supply valve is greater than the set value.
